(19) United States
(12) Patent Application Publication
(10) Pub. No.: US 2018/0373800 A1
(43) Pub. Date: Dec. 27, 2018

(54) METHOD OF STORING AND ORDERING INTERACTIVE CONTENT DATA IN LOCALIZED AND CONNECTED CONTENT DATA STRUCTURES

(71) Applicant: Alan Pizer, Kingston, NY (US)

(72) Inventor: Alan Pizer, Kingston, NY (US)

(21) Appl. No.: 16/018,161

(22) Filed: Jun. 26, 2018

Related U.S. Application Data
(60) Provisional application No. 62/525,330, filed on Jun. 27, 2017.

(51) Int. Cl. G06F 17/30

(52) U.S. Cl. CPC G06F 17/30896; G06F 17/30873; G06F 17/30882; G06F 17/30905

(57) ABSTRACT

A method of storing and ordering interactive content data in localized and connected content data structures, such that content data data files may be displayed and interacted with on a single browser page.

### PRIORITY CLAIM

This application claims the benefit and priority of U.S. provisional patent application 62/525,330, filed Jun. 27, 2017. The above referenced application is incorporated herein by reference as if restated in full.

### BACKGROUND

Currently, internet users browse the internet by looking at different pages, with one page taking them to another page via hyperlinks. Generally, each page lacks the context of the other pages that led to it, except the presence of the hyperlinks that let the user move backwards to the preceding page or a different page altogether. However, by doing this, the current page disappears, because only one page can be seen within a browser at any point in time. In order to see multiple pages simultaneously, multiple browsers must be opened—but there is no functionality that connects the flow of information between the separate browsers. Instead, each browser would constitute its own information stream. Content sharing platforms like YouTube partially convey the context of any one given video by displaying the links to other views in an adjacent column—but these links must be selected, whereupon the browser brings the user to a new page. It could be said that the existing applications provide a centrifugal experience for the user, in that exploring the internet takes the user away from their current focus, but there is nothing that provides a centripetal experience for the user by maintaining their current focus but providing additional contextual information for readjusting the focus. Specifically, there is no application that enables a user to view and interact with multiple information streams simultaneously in a single browser.

### SUMMARY

The present inventions relates to a content sharing platform. The platform comprises a curator domain and a viewer domain. In the former, content is aggregated and arranged by a curator. In the latter, the aggregated and arranged content is navigated by a viewer.

In one embodiment, a user of the platform is either a curator or a viewer. In one variation of this embodiment, a user must apply to one or separately to both accounts. The two accounts feature different subscription-based entry and use requirements. Examples of entry and use requirements include signing up for an account using conventional methods, logging in, and/or paying a monthly, annual, or one-time fee. In another variation of this embodiment, a user may sign up for one account, such as one providing access to the viewer domain, and then “upgrade” or elect additional features so as to access and use the curator domain. This may require, for example, paying a fee of some kind.

In another embodiment, the curator domain and viewer domain are coexisting during a given user's use of the platform. In this embodiment, the division between curator domain and viewer domain is merely an intellectual construct for the purpose of identifying related tasks and actions, and bears no consequences in the graphical interface or underlying software.

In yet another embodiment, users may have access to or are enabled to populate a single card (to be explained below) for a first price, but have to pay a second price to access or populate a deck (to be explained below). In one variation, the first type is a freemium model whereas the second type is for a subscription fee. In another variation, the first type provides for more than one card. In yet another variation, the second type provides for a single deck, and a third type provides for multiple decks.

In one aspect, the curator domain comprises a card. The card is a set of content, including pictures, videos, music, and/or combinations thereof. An article of content could be understood or expressed in one of a set of “screens” that appear in the card interface. The screens may be separated by borders or may border one another without separation. The card may also be referred to as a “dec”.

Each card may be assigned a “card code”, which may comprise any combination of letters and/or numbers, including a proper, default, or modified title, so as to distinguish it from other cards. Each card features a display state, in which the articles of content that comprise the card are displayed, each in its own “screen” or portion thereof in the user interface, and accordingly numbered, from top left and clockwise thereafter to the center, 1, 2, 3 . . . etc. This number may be referred to as the “content number” and is used to identify not the article of content directly, but rather, the position that the article of content occupies. Each article of content may instead be given an “article code”, which may comprise any combination of letters and/or numbers, or it may comprise a proper, default, or modified title. The identification scheme heretofore discussed, as well as any and all that proceed, are merely functional examples, and should not limit the type or kind fathomed by this application.

In one aspect, the card comprises a population feature. The population feature, which may have a graphical representation on or adjacent to a given card, may have two components: the current number of articles of content that reside in the card, and the maximum number of articles of content that reside in the card. The maximum number of articles of content can be a default number selected and maintained by the platform, or selected by the user, e.g., by a drop drop down menu consisting of numbers and/or an entry field. If a card has a greater maximum number than a current number, then the remaining numbers are said to be “waiting”. As discussed above, articles of content may be assigned article numbers to correspond to their position in the card. Positions not occupied by articles of content are said to be “waiting positions”. In one aspect, the cards and articles of content exist in a layered hierarchy whereby one or more articles of content may be linked to one or more cards. Linkage can occur singly, doubly, or any number of times for a given article of content or card, at the discretion of the curator. In one embodiment, articles of content, positioned on a given card, may be linked to a different card. In this manner, the given card is linked via the article of content to the different card. In another embodiment, a card may also be linked directly to another card.

In one embodiment, linkage occurs by means of a linking feature, which may have a graphical representation on or adjacent to a given article of content or card, perhaps in an alternately hidden/revealed form which may be “toggled” by the curator, or as part of a menu of options situated elsewhere on the graphical interface of the platform. In one embodiment, the curator accesses the linking feature for a given article of content or card and enters one or more card codes into a field or selects one or more card codes from a drop down-menu.

In another embodiment, linkage occurs by dragging a card or an article of content from a card and matching it with a given card. In yet another embodiment, one or more linkages may occur by selecting the linking feature on a given card or article of content, and then selecting the graphical representations of a card or article of content and a separate card. This provides for activity called “Rabbit Holing”, which enables a user to navigate through cards in a deck, where the article of content selected provides a unique pathway to a separate but determined card. In one variation, the sequence of cards in Rabbit Holing is random.

In one aspect, breadcrumbs may be displayed in the user interface identifying where in the deck a user has entered. In one variation, the breadcrumbs comprise a series of icons, texts, or links that correspond to previous cards the user has accessed or are prior to the card he is currently viewing. In another variation, breadcrumbs also identify cards that follow the one currently viewed. In yet another variation, breadcrumbs only identify cards that follow the one currently viewed if the user has actually visited or seen them, and then moved backward to the prior card he is currently viewing.

In one aspect, linkages can be broken or canceled. In one embodiment, the graphical representation of a linkage can be dragged away from the graphical representation of a given card or article of content, and released in a non-active area of the user interface, or dropped into a recycling bin or garbage-type icon or space. In another embodiment, a graphical representation of the cancellation of a linkage on or adjacent to a card or article of content may be selected. In a variation thereof, the graphical representation of the linkage is also the representation of the cancellation of that linkage.

In one embodiment, the article of content that is linked to another card is added to the set of content such that it occupies a “central position”, which will be discussed later. In another embodiment, every card features a “central position” which is kept “waiting”, until the card is linked by an article of content; once linked, the central position is no longer “waiting” but instead “participated in”, viz., the central position may at least be occupied by that linking article of content, provided that the card is accessed or viewed by following that linking article of content to the card featuring the central position. A given central position of a given card may be “participated” in by one or more articles of content so that the article of content that actually “occupies” the central position at a given time is dependent on the article of content that is selected and followed to the given card.

In one aspect, the curator domain comprises a network feature. The network feature permits a curator to access the library of one or more other curators. The curator may link any of the curator's own cards and/or content to another curator's content and/or cards. In one embodiment, the network feature comprises a privacy feature. The privacy feature may have a graphical representation on or adjacent to each card and/or article of content, and may permit the curator to identify whether a given card and/or article of content is merely viewable, “linkable”, and/or “downloadable” (to be discussed later), to the public or a modifiable list of other curators and/or viewers.

In one aspect, the curator domain comprises a library. The library is a set of all content that has already been sourced (see below) to the curator's domain of the platform. One or more articles of content may be “transferred” to one or more cards by either selecting a “send to” feature, composite with the name or identification code of a card and/or a drop-down menu listing all of the cards, or by dragging the content from the library into a given card. Even if an article of content is transferred to a card, it remains in the library; similarly, if an article of content is deleted from a card, it is not removed entirely from the platform for it remains in the library. However, if it is deleted from the library, it is removed from the platform.

A collection of one or more cards, wherein each card is linked, either via one of more of its articles of content or directly, to at least one other card may be referred to, collectively, as a deck. Each deck may be assigned a deck code, a title, and a pictoral representation, although in one variation, the deck code is identical to the title, as a card code may be identical to its title. If a pictoral representation is not designated, then a card may be automatically designated, preferably a card which, while linked to other cards, is not linked by other cards, which indicates that it is the first card in a deck. A deck, which comprises multiple cards, may also be referred to as “dex”.

In one embodiment, the library lists and/or displays all of the articles of content, cards, and/or decks viewable, accessible, or otherwise “possessed” by a given curator. In another embodiment, each article of content, card, and/or deck is listed and/or displayed with a set of parameters, either situated adjacent to the title, code, or pictoral representation, or displayed when the cursor hovers over the same. In one embodiment, when a card or deck, listed or displayed in the library, is selected, its contents are listed or displayed, e.g., a set of articles of content or a set of cards. If displayed, the contained articles of content are situated in their respective positions. In another embodiment, all cards and/or decks displayed in the library automatically list or display their contained articles of content and/or cards.

In one aspect, the curator domain comprises a sourcing feature. The sourcing feature permits the curator to add content to the curator's library and/or card. In one embodiment, the sourcing feature permits the curator to add content from the internet. In another embodiment, the sourcing feature may permit the curator to add content from the curator's computer, mobile device and/or dedicated hardware. In yet another embodiment, the sourcing feature may permit the curator to add content via the network feature, in which content is “downloaded” from another curator's library.

In one embodiment, the sourcing feature may comprise an address field, in which the curator can enter the URL where the content resides. In another embodiment, the sourcing feature may comprise a browser feature, such that the browser feature is embedded in the content sharing platform, and the curator can navigate the internet and select desired content by using a selection feature. In yet another embodiment, the sourcing feature may comprise a separate software, or operate as a plug-in for a separate software. In this embodiment, the sourcing feature is a plug-in and may be supported by a browser. The sourcing feature may appear in the browser's drop-down menu or be displayed prominently as an icon on the browser's frame, as is conventionally done by Pinterest and other popular online platforms. The plug-in may allow a curator to select content appearing within the browser through the use of a native or proprietary graphical cursor, perhaps ornated in the present platform's trademark, by clicking or otherwise selecting the content, or indicating the beginning of a selection and then dragging a geometrical shape across the desired portion of the content. Or the plug-in may allow a curator to select a time sequence of the content by either activating a key or cursor function, and then activating the same key or cursor function once the desired time sequence has terminated, or by activating and holding the key or cursor selection until the desired time sequence has terminated. Or the plug-in may allow a user to send the content to the platform via a selection menu, e.g., by right clicking on the content, and selecting the appropriate command, perhaps identified as “send to card”. In one embodiment, various parameters of the content are selectable for transfer to the card, such as time codes, graphical dimensions, and/or any other suitable limitating elements.

In one embodiment, the sourcing feature may comprise a browse function, in which an option to browse the storage space of a device on which the platform is running and/or any ancillary devices connected to that device, such that one or more articles of content may be selected and thereby “uploaded” to the card.

In any of the above-mentioned embodiments, the sourcing feature may permit the curator to select the one or more cards and/or the library to which the content is to be sent and/or uploaded, by selecting from a drop-down menu, or by entering a given name or identification code in a “source to” field. In one embodiment, the curator may identify the location or position within one or more given cards to which the content is to be awarded.

In any of the above-mentioned embodiments, the sourcing feature may be used in conjunction with the network feature, thereby permitting a curator to upload to the curator's account articles of content and/or cards from another curator.

In any of the above-mentioned embodiments, the sourced content can be added to a given card, in which case the article of content is added to the first “waiting position”, or the article of content can be assigned, by any of the above methods, to a particular “waiting position”. In one embodiment, if the article of content is assigned a position already occupied by an article of content, then all of the articles of content in that card are moved down one position. In another embodiment, the displaced article of content is moved to the first available “waiting position”. In yet another embodiment, an error message informs the curator that the position is already occupied.

In one embodiment, the curator domain comprises an edit feature. One or more articles of content may be modified in the same manner in which content may be modified by any conventional image or video based editing software, such as Photoshop, Gimp, Premiere, etc.

In one aspect, the viewer domain comprises a library. This library may be separate or identical to the library of the curator domain. The viewer library comprises one or more cards and/or decks, listed or displayed via pictoral representations, either in closed (single image) or open (content-display) fashion. When a given card is selected, that card may open and/or expand so that the articles of content, arranged in their respective positions, take up a portion of the user interface screen suitable for viewing. This may be referred to as a card's “display state”.

In one embodiment, the display state of a card features a central, or primary position, and satellite or secondary positions. In one variation of this embodiment, the article of content in the central position features a larger viewing area than the satellite positions. In one example of this variation, the graphical measurements of an article in a satellite position is x by y, whereas for an article in the central position, it is 2x by 2y. In another variation of this embodiment, the article of content in the central position is “active” whereas the articles in the satellite positions are “passive”. The quality of being “active” refers generally to the activation of the time feature of a video or animation, i.e., it is being played; the quality of being “passive” described videos or animations that are not playing. In another embodiment, there is no corresponding relationship between the central position and the quality of being “active”, nor between the satellite position and being “passive”; instead, any article of content can be rendered active or passive based on the discretion of the viewer.

In one variation of this embodiment, the viewer renders an article, regardless of its position, “active” by selecting it, or by selection a portion of it, such as a graphical representation of playing, e.g., the play button. That article then plays, regardless of its position. Alternatively, a given article can be made active if a viewer hovers a cursor over it. In another variation of this embodiment, if an article is selected to play, that article will “move” to the central position so as to occupy it, while the displaced article moves either to the now “waiting” position.

In any of the variations of the above two embodiments, (the one in which an active article moves to the central position, and the one in which an active article merely plays), the active video may so to speak, play where it left off, i.e., continue at the time position it last held when active, or it may restart from the beginning of its time track.

In one embodiment, if a given article of content is selected on a given card, that card is replaced by the card linked by the article of content selected, and the article of content then occupies the central position. In this manner, the “participation” in the central position is fulfilled. In one variation of this embodiment, if the article of content selected does not link to any other card, then it instead participates or occupies the central position of its own card. In an alternative variation of this embodiment, that non-linking article will occupy the central position of the initial card, i.e., the one which began the “deck”, which then will be displayed. In another variation of this embodiment, if a given article of content is selected, it is merely made active. Additional or different means of selecting that same article may cause it to occupy the central position of the card. Yet additional or yet different means of selecting that very same article may then cause the card to which it is linked to replaced the current card. In one type of this variation, that selected article occupies the central position of the new card. In another type of this variation, it does not; instead, an article, preferably the first numerically, that is positioned on that card will occupy the central position.

Each Article of Content may be provided a unique URL. That URL may correspond to the location of the article of content from where it was sourced on the internet, such as a content display platform like Youtube. In this manner, the platform does not need to host the data itself. Also, each card may have a unique URL, allowing the card to be easily exchanged online. Each deck may have one or more URLs, where the URL may correspond to the first card in the deck, or any card thereafter.

### BRIEF DESCRIPTION OF THE DRAWINGS

FIG. 1 is a flowchart showing an exemplary method.

FIG. 2 shows an exemplary system configuration.

FIG. 3 shows an exemplary data structure.

FIG. 4 shows an exemplary data structure and user interface.

FIG. 5 is a flowchart showing an exemplary method.

FIG. 6 is a flowchart showing an exemplary method.

FIG. 7 is a flowchart showing an exemplary method.

### DETAILED DESCRIPTION

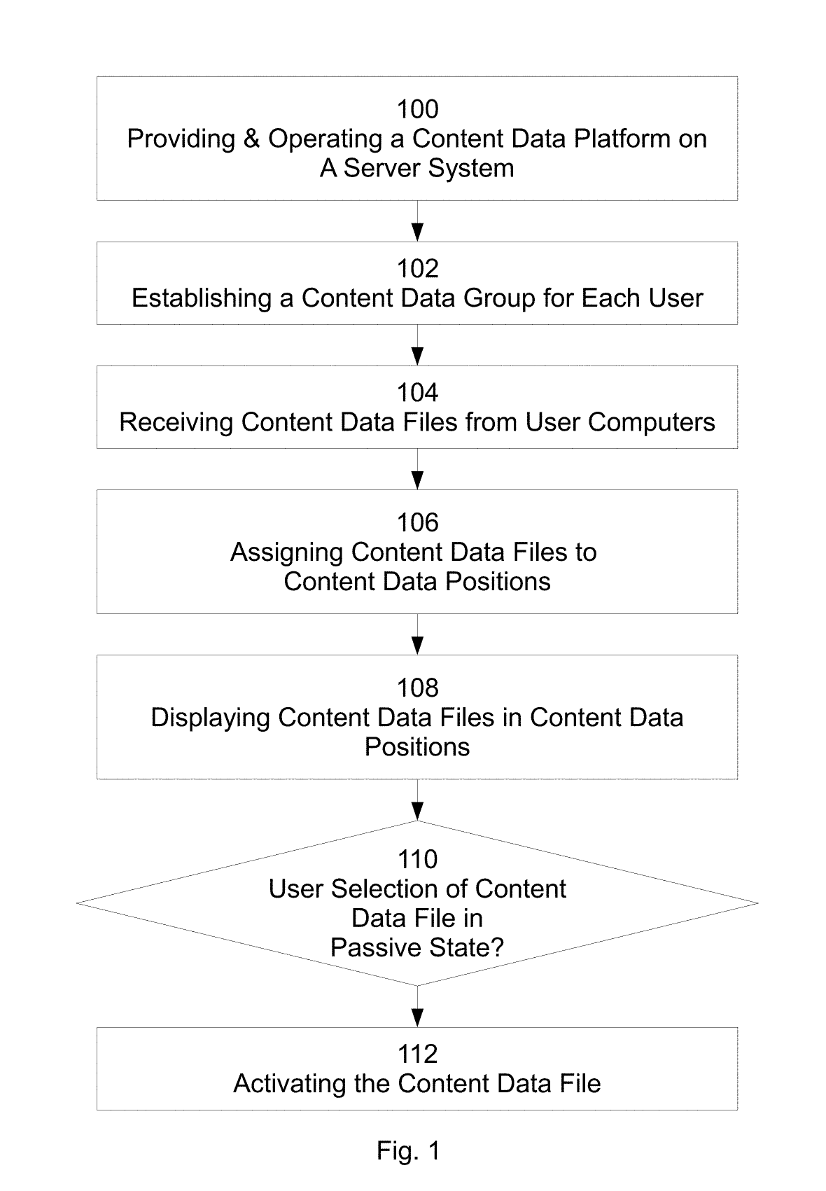

FIG. 1 is a flowchart showing an exemplary method of linking content data files, such as music, video, or images, together in a presentation view made of a content data structure, such that the content data files may be displayed simultaneously. Steps include providing and operating a content data platform on a server system 100, establishing a content data group for each user 102, receiving content data files from user computers 104, assigning content data files to content data positions 106, displaying on a display screen the content data files in their content data positions 108, and if a user selection of a display of a content data file in a passive state is received 110, activating the content data file 112. The content data group may be a portion in a database where a user's library is stored, such that when a user adds to their library via the user interface, the link or data provided is added to the content data group dedicated to them. The user may activate or pacify several content data files, as represented by video or picture displays, by hovering or otherwise selecting them in turn, without leaving the card, as displayed on a single page of a browser.

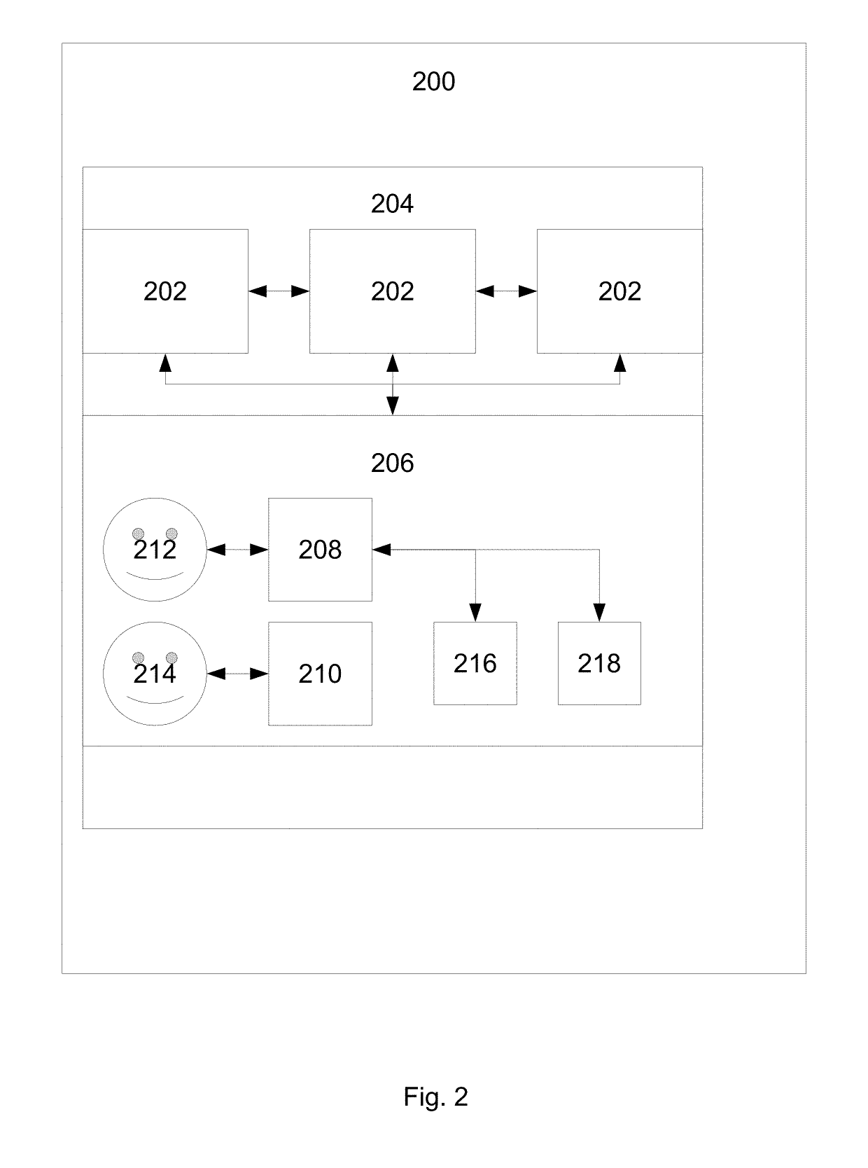

FIG. 2 shows a computer system configured to operate the content data platform. A server system 200, which may comprise one or more computers, processors, or cloud computers 202, is connected over a network 204, to a set of user computers 206. Each user computer, such as a first 208 and second 210 user computer, may be operated by a user, such as a first user 212 and second user 214. The first computer may comprise or be connected to a set of one or more input means 216, and a display screen 218.

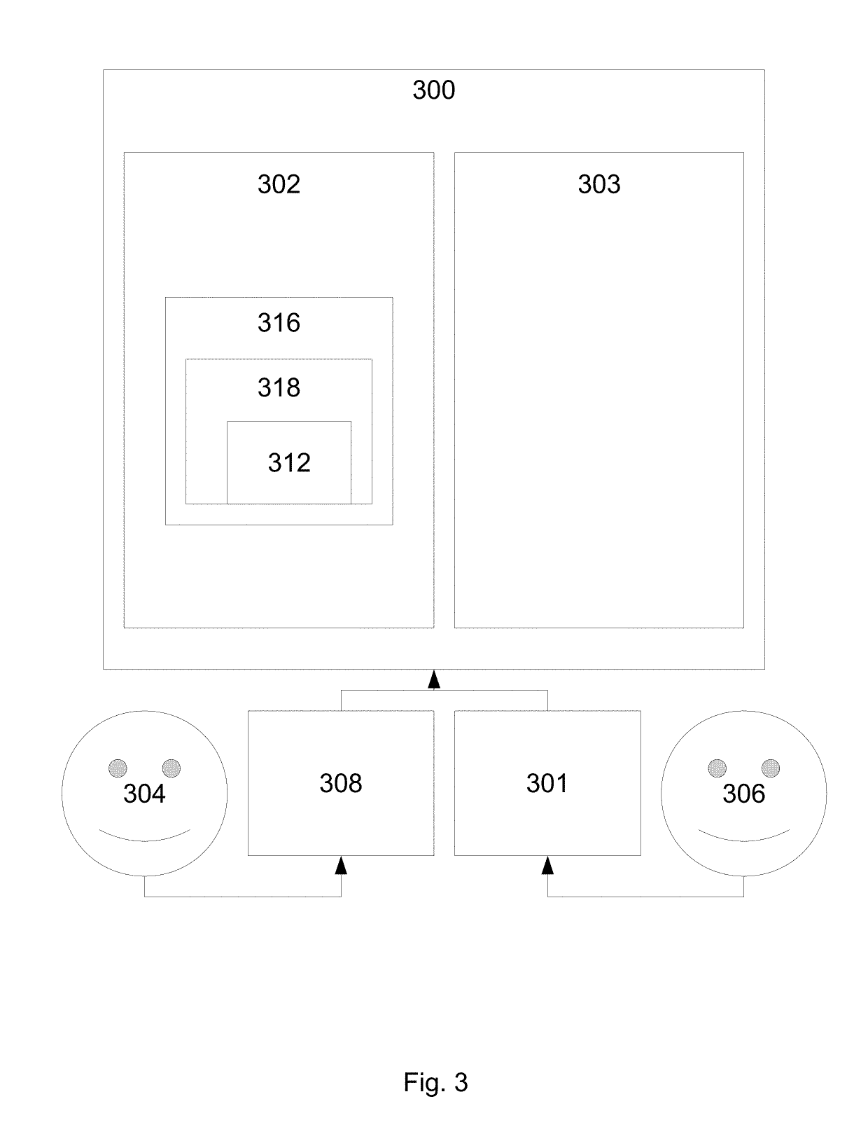

FIG. 3 shows a content data structure 300, which may comprise a unique content data group 302, 303, for each user 304 and 306. The content data structure may be influenced by any given user via one or more computers 308 and 310. The content data structure may receive a content data file 312 that may be saved to a user's content group 302, a content data card 316, or specifically, to a content data position 318 on a given content data card. The user has the option of saving a video or music file to their library, or to a specific card, in which case it may be simultaneously added to their library, or a specific position on a card.

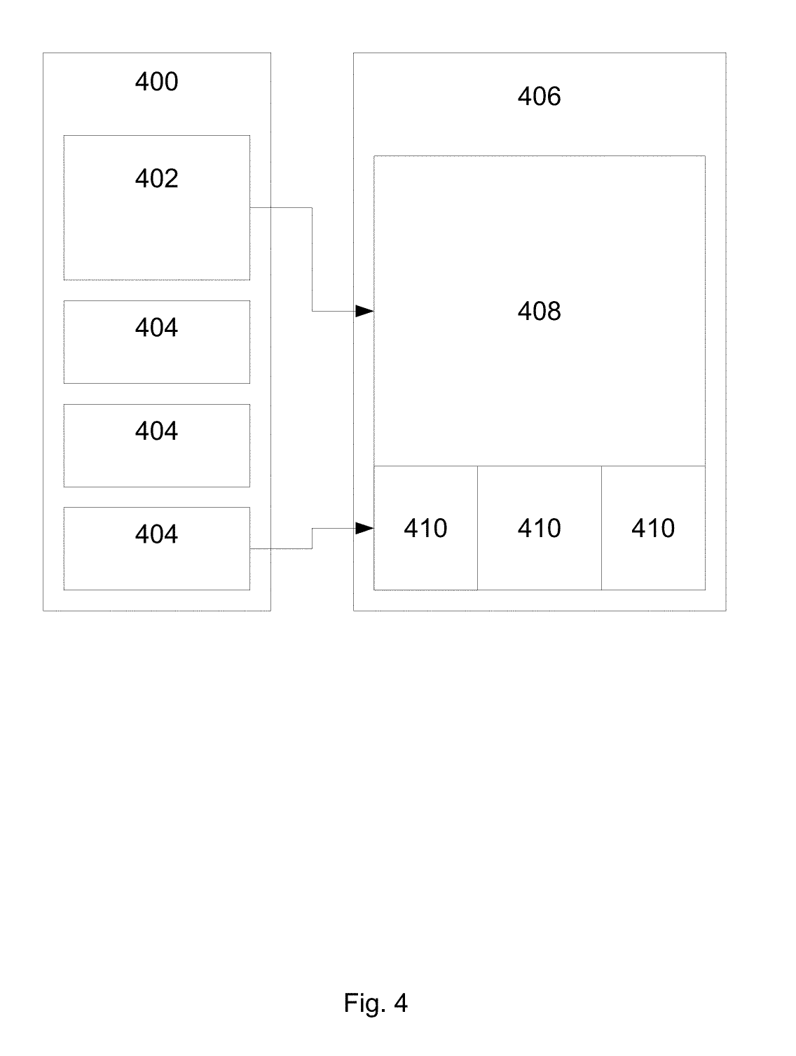

FIG. 4 shows that each content data card 400 may feature a central content data position 402 and a set of satellite content data positions 404. These positions may correspond to regions on a user interface 406, with a central region 408 being larger than a satellite region 410.

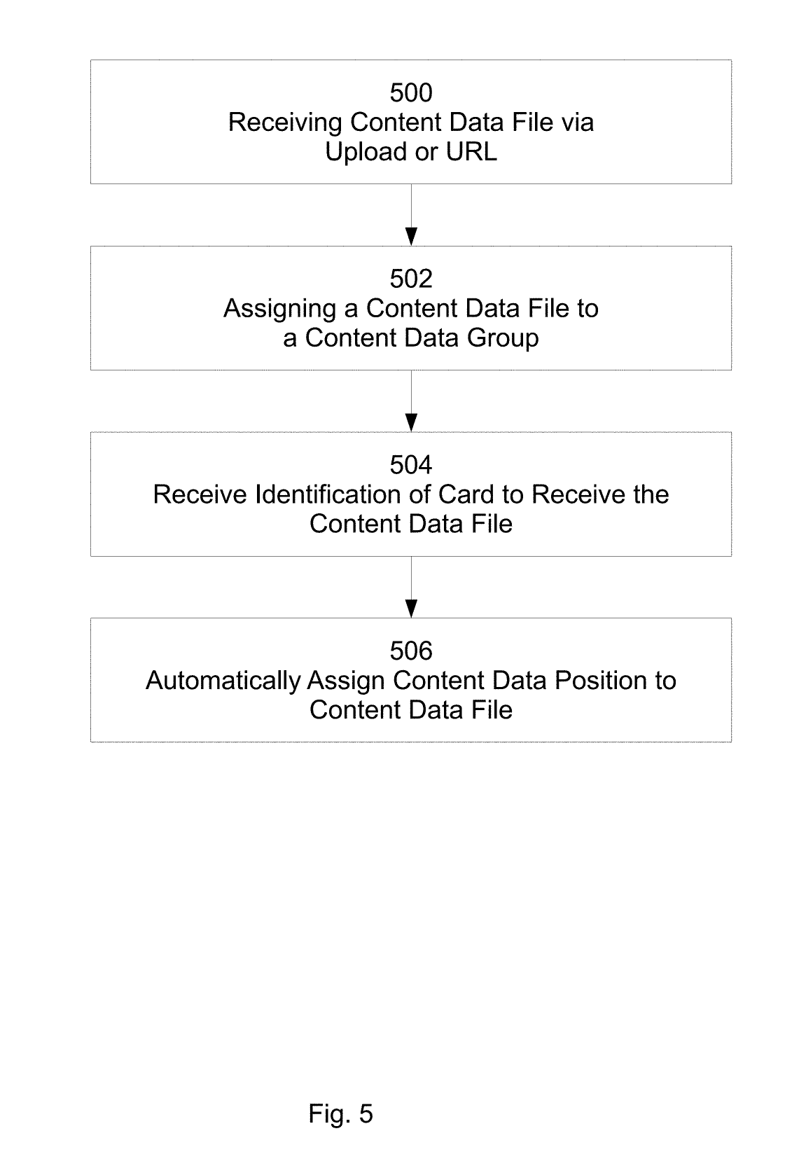

FIG. 5 is a flowchart showing the steps of assigning a content data file to a content data group 502, the content data group corresponding to a user's “library”, the assignation being triggered by a user uploading or providing a url of the content data file 500. Later, the user may identify the card 504 which he wishes to receive the content data file. The system may automatically assign a content data position 506, or the user may identify it.

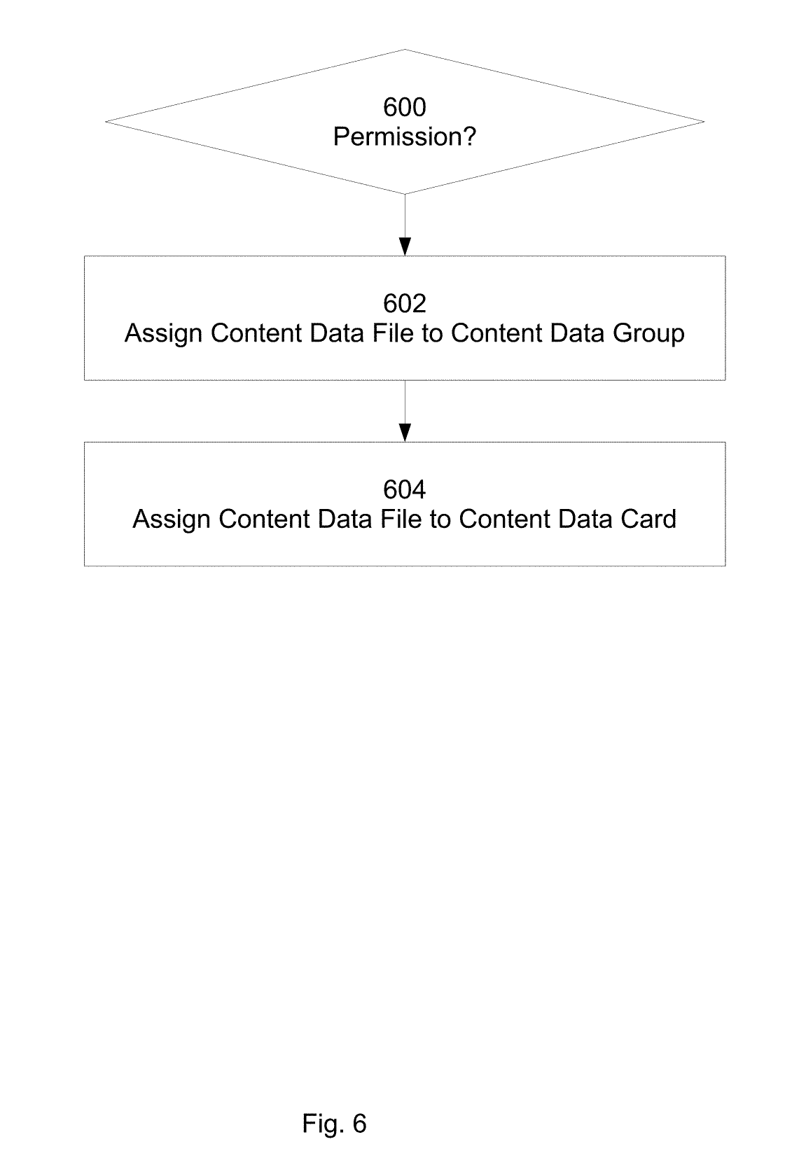

FIG. 6 is a flowchart showing that if permission is given by a first user 600 for another user or set of users, the other user may assign the content data file to his own content data group 602 and content data card 604.

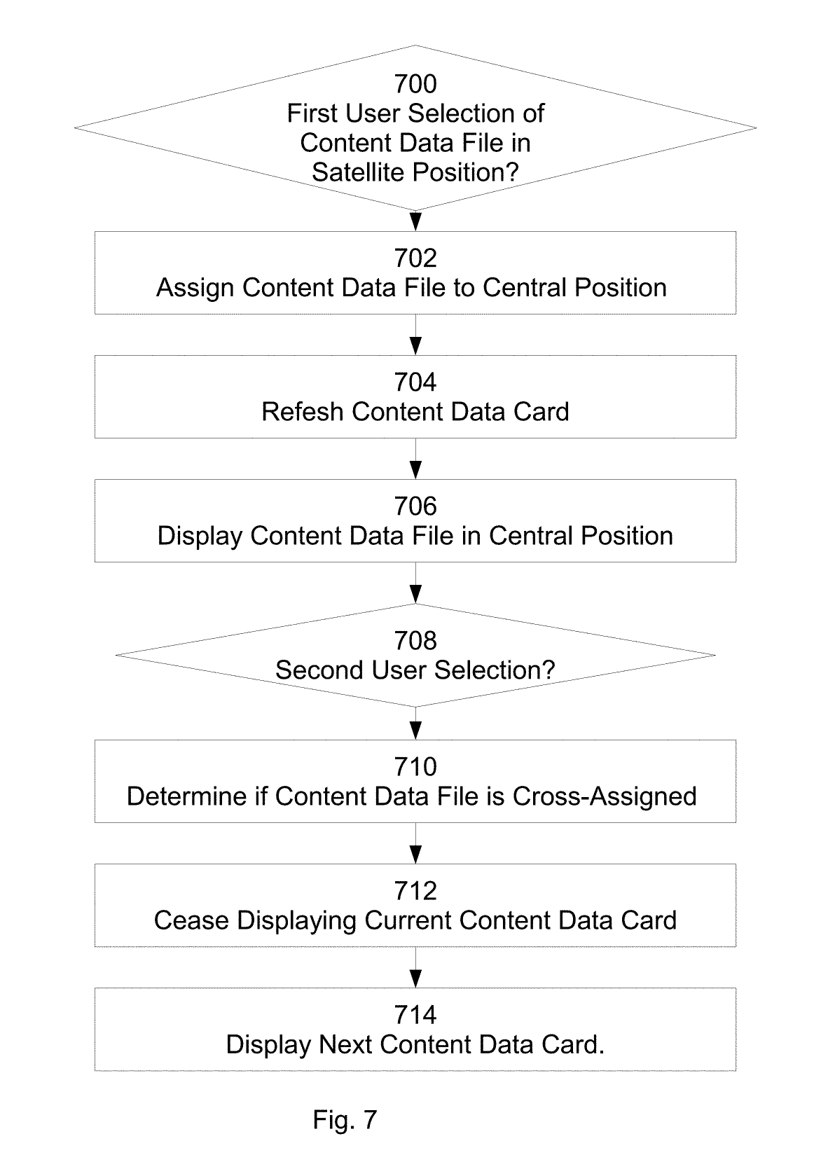

FIG. 7 is a flowchart showing that if a first user selection of a display of content data file in a satellite content data position is received 700, that content data file is assigned to the central content data position 702, the content data card is refreshed 704, and the content date will be displayed in a central position 706. If a second user selection of the content data file is made 708, the system will determine if the content data file is cross-assigned to another content data card 710, and if so, the system will cease displaying the current content data card 712, begin displaying the next content data card 714.

1. A method of linking content data files in a content data structure with simultaneous display features, including the steps of:
operating a content data platform on a server system, the server system comprising one or more remote server computers accessible over a network by a set of user computers, each user computer being operated by a user;
establishing a content data group for each user, each content data group comprising a content data card, each content data card comprising a set of content data positions;
receiving by the server system content data files from the set of user computers, the content data files comprising picture, video, or music data;
receiving from a user a unique assignation of each content data file to a content data position;
assigning content data files to content data positions;
displaying on a display screen, one content data card at a time, at least four content data files in their assigned content data positions;
upon receiving a user selection of a display of a content data file in a passive state, activating the content data file.

2. The method of claim 1,
each content data card having a central content data position and a set of satellite content data positions, with a display of content data files in central content data positions being larger than a display of content data files in satellite content data positions.

3. The method of claim 1, including the additional steps of:
assigning a content data file to a content data group, then upon receiving by the server system from a user computer a request to assign the content data file to a content data card, assigning the content data file to a content data position of the content data card.

4. The method of claim 3, including the additional steps of:
receiving from a user computer a request to assign the content data file to a content data position, then assigning the content data file to the content data position.

5. The method of claim 1, including the additional step of:
restricting a content data file received from a first user computer from being assigned to a content data card assigned to a content data group of a different user.

6. The method of claim 5, including the additional step of:
permitting the content data file to be assigned to the content data group of the different user if a request was received from the first computer assigning a public state to the content data file.

7. The method of claim 2, including the additional step of:
upon receiving a user selection of a display of a content data file in a satellite content data position, assigning the content data file previously in the satellite content data position to the central content data position.

8. The method of claim 1, including the additional step of:
upon activating the content data file, display all other content data files in the same content data card in the passive state.

9. The method of claim 1, including the additional steps of:
cross-assigning content data files assigned to a first content data card to a second content data card, then upon receiving a user selection of a content data file assigned to the first content data card and cross-assigned to the second content data card, ceasing displaying the first content data card, then displaying the second content data card.

10. The method of claim 9, including the additional step of:
upon displaying the second content data card, assigning the content data file cross-assigned to the second content data card to the central content data position of the second content data card.

11. A method of adding interactive content data files to a content data structure with simultaneous display features
providing a content data platform on a server system, the server system comprising one or more remote server computers accessible over a network by a set of user computers, each user computer being operated by a user;
establishing a content data group for each user, each content data group comprising a set of content data cards, each content data card comprising a set of content data positions;
receiving by the server system content data files from users, the content data files comprising picture, video, or music data;
assigning a set of content data files to a set content data positions of a first content data card and linking the first content data card to a second content data card, with both the first content data card;
displaying on a display screen, one content data card at a time, at least six content data files in their content data positions;
upon receiving a proceed selection of the first content data card, display the second content data card.

12. The method of claim 11, only permitting the linking of the first content data card to the second content data card if both the first and second content data cards are assigned to the same user.

13. The method of claim 11, only permitting the assigning of the set of content data files to the set of content data positions of the first card if the content data files and the content data card belong to the same content data group.

14. The method of claim 11, each content data card having a central content data position and a set of satellite content data positions, with a display of content data files in central content data positions being larger than a display of content data files in satellite content data positions.

15. The method of claim 14, including the additional step of:
upon receiving a user selection of a display of a content data file in a satellite content data position, displaying the content data file previously in the satellite content data position in the central content data position.

16. The method of claim 11, including the additional step of:
upon receiving a user selection of a display of a content data file in a passive state, activating the content data file.

17. A method of linking content data files in a content data structure with simultaneous display features, including the steps of:
providing a content data platform on a server system, the server system comprising one or more remote server computers accessible over a network by a set of user computers, each user computer being operated by one or more users;
establishing a content data group for each user, each content data group comprising a set of content data cards, each content data card comprising a set of content data positions;
receiving by the server system content data files from the set of user computers, the content data files comprising picture, video, or music data;
assigning content data files to content data positions in some content cards and cross-assigning content data files to other content cards;
displaying on a browser page on a display screen, one content data card at a time, content data files in their content data positions, each content data file capable of being activated by a user without leaving the browser page.

18. The method of claim 17, including the additional steps of:
upon receiving a user selection of a content data file assigned to a first content data card and cross-assigned to a second data card, ceasing displaying the first content data card, and displaying the second content data card.

19. The method of claim 18, each content data card having a central content data position and a set of satellite content data positions, with a display of content data files in central content data positions being larger than a display of content data files in satellite content data positions.

20. The method of claim 19, with content data files assigned to the central positions of content cards they are cross-assigned to.
